(19) United States
(12) Patent Application Publication
(10) Pub. No.: US 2008/0177398 A1
(43) Pub. Date: Jul. 24, 2008

(54) Treatment of bladder dysfunction

(76) Inventors: Yossi Gross, Moshav Mazor (IL); Dan Goldstein, Efrat (IL)

Correspondence Address: ABELMAN, FRAYNE & SCHWAB, 666 THIRD AVENUE, 10TH FLOOR, NEW YORK, NY, 10017, US

(21) Appl. No.: 11/657,785

(22) Filed: Jan. 24, 2007

(51) Int. Cl. G05B 11/01

(52) U.S. Cl. 700/11

(57) ABSTRACT

A method is provided for treatment of bladder dysfunction of a patient. The method includes, at a site within a patient, measuring an indication of fill-level of a bladder of the patient, and in response to an indication of a high bladder fill-level, conveying a signal indicative of the high bladder fill-level to the patient in a humanly-perceptible manner. Other embodiments are also described.

### FIELD OF THE INVENTION

The present invention relates generally to implantable medical apparatus. Specifically, the present invention relates to an implantable apparatus to detect and convey a state of the bladder.

### BACKGROUND OF THE INVENTION

Diabetes, vaginal childbirth, stroke, multiple sclerosis, AIDS, and other events or conditions can impede signal transmission to the brain indicating that the bladder is full. When as a result the bladder becomes too full, fluid pressure in the bladder backs up and may damage the kidneys. Benign prostatic hypertrophy (BPH) can also exacerbate the rise in bladder pressure. Chronic bladder over-distention, loss of bladder contractility, overflow incontinence, and bladder, ureter, and kidney infections often result from an over-filled bladder. Lack of patient awareness of bladder distention over the long term leads to hypotonicity of the detrusor muscle. Treatment for urinary retention (defective bladder function due to impaired innervation) often includes the use of a catheter several times a day to empty the bladder (clean intermittent bladder catheterization).

In diabetics, neurogenic bladder often appears ten or more years after the onset of diabetes mellitus. Neurogenic bladder occurs because of autonomic and peripheral neuropathy, associated with overall diabetic neuropathy expressed in various locations in the body. Urodynamic indications include elevated residual urine, decreased bladder sensation, impaired detrusor contractility, and detrusor areflexia.

An article by Kaplan S et al., entitled, “Diabetic cystopathy,” J Diabet Complications. 1988 July-September; 2(3):133-9, which is incorporated herein by reference, states that diabetic cystopathy refers to the spectrum of voiding dysfunction in patients with diabetes mellitus. Diabetic cystopathy is marked by insidious onset and progression with minimal symptomology. The most common urodynamic findings are impairment of bladder sensation, increased post-void residual volume, decreased detrusor contractility that may progress to detrusor areflexia and diminished urinary flow. Asymptomatic patients with manifestations of diabetic cystopathy may be treated with timed voiding. In contrast, the sine qua non for therapy in symptomatic patients is clean intermittent catheterization. While other modalities such as pharmacologic and surgical intervention have been described, the article states that none have been consistently effective.

An article by Yerkes A M, entitled, “Urinary incontinence in individuals with diabetes mellitus,” Diabetes Spectrum, Volume 11:4, 1998, Pages 241-247, which is incorporated herein by reference, notes that neurogenic bladder is considered a form of autonomic neuropathy. It begins with selective damage to autonomic afferent nerves, leaving motor function intact but impairing the sensation of bladder fullness and, therefore, resulting in decreased urinary frequency. As this neuropathy progresses, autonomic efferent nerves become involved, leading to incomplete bladder emptying, urinary dribbling, and overflow incontinence. Primary symptoms of neurogenic bladder are impaired sensation of bladder fullness, weak urine stream, periodic or constant dribbling, unexplained sudden urination, need to strain to void, sensation of incomplete bladder emptying, urinary retention or a post-void residual volume of 90-500 ml of urine, and urinary tract infections. Incomplete bladder emptying may lead to urinary tract infections, which can be compounded with vaginal infections in women. Persistent residual urines of 400 ml or greater may lead to renal damage. Intermittent catheterization stimulates normal physiology by allowing for periodic filling and emptying of the bladder. It also prevents bladder over-stretching or shrinkage and minimizes the risk of infection.

An article by Fraser M O et al. in Reviews in Urology, 2002 Winter; 4(1): 1-11, entitled, “The future of bladder control-intravesical drug delivery, a pinch of pepper, and gene therapy,” which is incorporated herein by reference, states that many diabetics will develop a sensory neurogenic bladder (diabetic cystopathy) within 10 years of disease onset. The symptoms are progressive, and include decreasing bladder sensation and increasing bladder capacity. The end result is a large and acontractile bladder that is treated by catheterization or urinary diversion. The article states that there are no medical treatment options for diabetic sensory neuropathy.

An article by Hong-Jeng Yu et al., in Diabetes Care 27:988-989, 2004, entitled, “Unrecognized voiding difficulty in female type 2 diabetic patients in the diabetes clinic: A prospective case-control study,” which is incorporated herein by reference, notes that patients with diabetes may develop diabetic cystopathy, which is characterized mainly by impaired detrusor sensation and contractility. Impaired detrusor contractility may lead to incomplete bladder emptying and subsequently result in voiding difficulty, urinary retention, chronic urinary tract infection (UTI), and upper urinary tract damage. Although diabetic cystopathy is common, with a reported prevalence ranging from 25% to 87%, it is frequently not recognized by patients and physicians due to its insidious development and inconspicuous symptoms. Usually, genitourinary dysfunction in diabetic patients has reached an advanced stage by the time urologists are consulted. The article indicates that unrecognized voiding difficulty is common in female type 2 diabetic patients regularly treated in the outpatient clinic.

An article by Castro J C et al., in J Ultrasound Med 23:1307-1313, October 2004, entitled, “Sonographic evaluation of bladder volume in diabetic children and adolescents compared with nondiabetic subjects,” which is incorporated herein by reference, states that an increase in volume and evidence of postvoiding residuals are both encountered in the bladder of diabetic patients and can lead to urinary tract infections and impair renal function. They compared the bladder volume of diabetic children and adolescents with that of nondiabetic subjects between 3 and 21 years. The median full bladder volume was larger in the diabetic group (268 mL) than in the control group (220 mL). Postvoiding residual volume after spontaneous and forced voiding was significantly higher in the diabetic group. Multivariate analysis showed that being diabetic, older than 9 years, and female all influenced full bladder volume. They concluded that sonographic evaluation showed incipient bladder dysfunction in diabetic patients.

An article by Yoshimura N et al., entitled, “Recent advances in understanding the biology of diabetes-associated bladder complications and novel therapy,” British Journal of Urology International, 2005, 95:733-738, which is incorporated herein by reference, notes that urological complications have increasingly become a concern in those affected by diabetes mellitus (DM) Type I and diabetes mellitus Type II. More than a quarter of diabetic patients will develop costly and debilitating urological complications, e.g., incontinence, infections, loss of sensation, and retention of urine.

U.S. Pat. No. 6,354,991 to Gross et al., which is incorporated herein by reference, describes a device and method for treatment of urinary stress incontinence. At least one electrode is implanted in a pelvic muscle of a patient. A control unit receives signals indicative of abdominal stress in the patient and responsive thereto applies an electrical waveform to the electrode which stimulates the muscle to contract, so as to inhibit involuntary urine flow through the patient's urethra due to the stress.

U.S. Pat. No. 6,712,772 to Cohen et al., which is incorporated herein by reference, describes a pressure-measuring apparatus, including a battery and a pressure transducer. The pressure transducer is adapted to be placed in a patient, and has a characteristic mechanical response bandwidth f, and a corresponding mechanical response period p equal to 1/f. A control unit is adapted to actuate the battery to drive current through the pressure transducer for a current-driving time period less than 0.5 p, and to sense an electrical characteristic of the pressure transducer during the current-driving time period.

U.S. Pat. No. 6,086,549 to Neese et al., which is incorporated herein by reference, describes a device for applying electrical stimulation to a body cavity. Embodiments provide the function of measuring the pressure exerted by the body cavity. By providing electrical stimulation to the vagina, the device is described as strengthening the pelvic floor muscles to improve urinary continence. The embodiments which provide the function of measuring the pressure exerted by the body cavity convey to a user in a humanly perceptible manner, the pressure exerted by the body cavity in order to provide feedback on the strengthening of the pelvic floor muscles. The pressure transducer includes a semiconductor diaphragm sensitive to changes in pressure.

U.S. Pat. No. 6,743,165 to Mosel et al., which is incorporated herein by reference, describes devices, systems, and methods for diagnosing and/or treating urinary incontinence to accurately and reliably monitor both a vesicle pressure and a maximum urethral pressure of a patient during an abdominal pressure pulse so as to determine relationships between these pressures. Alignment between the location of maximum urethral pressure and a pressure sensor of a catheter can be maintained using an anchoring structure having a surface which engages a tissue surface along the bladder neck, urethra, or external meatus, which move with the urethra during abdominal pressure pulses. A pressuregram is generated graphically showing an increase in urethral pressure relative to an increase in vesicle pressure, and is often displayed in real time to a system operator adjacent the patient. Quantitative and/or qualitative diagnostic output, allow selective remodeling of the patient's support structure so that the incontinence is inhibited.

U.S. Pat. No. 6,061,596 to Richmond et al., which is incorporated herein by reference, describes a system and method for conditioning pelvic muscle tissue for the purpose of treating urinary incontinence uses one or more tiny implantable stimulators termed “microstimulators” implanted in or near certain pelvic structures so as to contact target muscle tissue. The microstimulators are described as being small enough to allow their implantation using a hypodermic needle. Once implanted, the microstimulators are controlled using a controller and an appropriate coupling coil that couples modulated radio frequency power into the microstimulators. A fitting station facilitates adjusting the stimulus pattern and amplitude to best meet the needs of a given patient. Once fitted, electrical stimulation is thus provided to the target tissue in accordance with a specified externally-controlled exercise or other regime.

U.S. Pat. No. 6,735,474 to Loeb et al., which is incorporated herein by reference, describes a method and system for treatment of incontinence and/or pelvic pain includes implantation of one or more battery- or radio frequency-powered microstimulators beneath the skin of the perineum and/or adjacent the tibial nerve. The devices are programmed using radio-frequency control via an external controller that can be used by a physician to produce patterns of output stimulation pulses judged to be efficacious by appropriate clinical testing to diminish symptoms. The stimulation program is retained in the microstimulator device or external controller and is transmitted when commanded to start and stop by a signal from the patient or caregiver. The system and method reduce the incidence of unintentional episodes of bladder emptying by stimulating nerve pathways that diminish involuntary bladder contractions, improve closure of the bladder outlet, and/or improve the long-term health of the urinary system by increasing bladder capacity and period between emptying. Furthermore, the system and method reduce or eliminate the incidence of pelvic pain by chronically stimulating nerve pathways that derive from the sacral roots using a miniature implantable neurostimulator that can be implanted with a minimal surgical procedure. Moreover, the system and method allow a patient to be taught to receive one or more patterns of neural stimulation that can be prescribed by a physician and administered without continuous oversight by a clinical practitioner.

PCT Publication WO 00/25859 to Rijkhoff et al., which is incorporated herein by reference, describes a method to control an overactive bladder and to estimate bladder volume, comprising an implanted sensor, which sensor comprises at least one nerve electrode to sense electrical signals, means for stimulation of nerves to inhibit detrusor contraction, an electronic unit to detect events from nerve signals and generate electrical pulses for stimulating nerves. The object of the method is described as treatment of involuntary loss of urine (incontinence) due to involuntary detrusor contractions (detrusor overactivity). Another object of the method is estimation of bladder volume. This finds particular application in patients who use aids to empty their bladder e.g. intermittent catheterization or electrical stimulation.

U.S. Pat. No. 6,970,091 to Roe et al., which is incorporated herein by reference, describes a method of urinary continence training, utilizing an objective measurement, indicative of the state of fullness of the bladder of the subject, to identify the occurrence of an appropriate continence training opportunity. When the objective measurement equals or exceeds a signal threshold value, set to correspond to a bladder volume that is less than a reflexive urination volume, a signal is provided to the subject or to a caregiver. The objective measurement may be performed by a bladder monitor, using any of several modalities of automatic sensing, and preferably using ultrasound. The signal threshold value may be recalculated and increased, so as to continue to correspond to a relatively full bladder, as the subject grows and/or achieves progress toward continence. The method may include other steps directed to help the subject associate the physical sensation of a full bladder with voluntary urination, such as informing the subject that urination is imminent.

U.S. Pat. No. 4,852,578 to Companion et al., which is incorporated herein by reference, describes a device and method for rapidly quantifying the relative distention of the bladder of a human subject. An ultrasonic transducer is positioned on a subject in proximity to the bladder, and is excited by a pulser under command of a microprocessor to launch an acoustic wave into the patient. This wave interacts with the bladder walls and is reflected back to the ultrasonic transducer, where it is received, amplified and processed by a receiver. The resulting signal is digitized by an analog-to-digital converter under command of the microprocessor and is stored in data memory. The software in the microprocessor determines the relative distention of the bladder as a function of the propagated ultrasonic energy; and based on programmed scientific measurements and individual and anatomical and behavioral characteristic of with the specific subject as contained in the program memory sends out a signal to turn on any or all of the audible alarm, the visible alarm, the tactile alarm, and the remote wireless alarm.

U.S. Pat. No. 5,411,548 to Carman, which is incorporated herein by reference, describes a method of varying the appropriate muscle strength of a person to at least alleviate urinary or fecal urgency or incontinence, or vaginal or bladder spasms. The method includes placing a surface electrode of electromyographic measuring apparatus at an appropriate position on the person and/or inserting a probe electrode of electromyographic measuring apparatus and/or pressure transducer probe of pressure measuring apparatus into the vaginal or anal passage of a person and measuring with the electromyographic or pressure measuring apparatus the appropriate muscle strength of the person while the person is tensing the appropriate muscles in a urine or feces stopping manner to obtain an EMG or pressure signal. The threshold value of a portable electromyographic or pressure measuring unit is then adjusted to enable the person to repeat the measurement at different times to attempt to obtain better EMG or pressure signals in an urge, incontinence or spasm reducing sense. The portable unit gives an audible and/or visual and/or tactile indication when an EMG or pressure signal representing an improvement relative to the threshold value is achieved.

U.S. Pat. No. 4,771,779 to Tanagho et al., which is incorporated herein by reference, describes a system for controlling bladder evacuation. The system includes first and second implanted stimulation systems having electrodes respectively positioned on nerves controlling external sphincter and bladder functions, and an electronic control system which operates to generate and transmit electrical sphincter stimulation pulses to the first stimulation system. When it is desired to evacuate the bladder, a switch is closed causing the electronic control system to discontinue the external sphincter stimulation and, after a predetermined delay, to generate and transmit electrical bladder stimulation pulses to the second stimulation system. After a predetermined time, the bladder stimulation is automatically stopped. After another predetermined delay, the electronic control system resumes the generation and transmission of sphincter stimulation pulses to the first stimulation system.

U.S. Pat. No. 6,393,323 to Sawan et al., which is incorporated herein by reference, relates to lower urinary dysfunctions and more particularly to an electronic stimulator implant and method to improve bladder voiding and prevent bladder hyperreflexia. An electronic stimulator implant comprises a tonicity signal generator generating a tonicity signal which prevents bladder hyperreflexia combined with a voiding signal generator generating a voiding signal for voiding the bladder. The implant is connected to an end of an electrode, and the second end thereof is connected to a sacral nerve. When a voiding key (or switch) is activated, the voiding signal is generated which activates detrusor muscle contraction, causing bladder voiding. The voiding may be achieved without dyssynergia, by activating detrusor muscle contraction without activating external urethral sphincter contraction. The tonicity signal may be provided intermittently. The implant may be activated by a manually activated external controller.

The following patents and patent application publications, which are incorporated herein by reference, may be of interest:

U.S. Pat. No. 4,881,526 to Johnson, et al.

U.S. Pat. No. 6,135,945 to Sultan, et al.

U.S. Pat. No. 5,733,230 to Sawchuck, et al.

PCT Publication WO 02/34328 to Dijkman, et al.

PCT Publication WO 94/15667 to Carman, et al.

PCT Publication WO 03/007885 to Loeb, et al.

U.S. Pat. No. 6,652,449 to Gross, et al.

U.S. Pat. No. 6,896,651 to Gross, et al.

U.S. Pat. No. 5,199,430 to Creasey, et al.

US Patent Application Publication 2004-0145343 to Naskali et al.

The following articles, which are incorporated herein by reference, may be of interest:

Boyce W H et al., “Research related to the development of an artificial electrical stimulator for the paralyzed human bladder: A review,” J. Urol. 91:41-51 (1964)

Brindley G S et al., “Sacral anterior root stimulators for bladder control in paraplegia: The first 50 cases. J. Neurol. Neurosurg. Psychiatry, 49 (10):1104-1114 (1986)

Jolleys J V et al., “Diagnosis and management of female urinary incontinence in general practice,” J. R. Coll. Gen. Pract. 39: 277-9 (1989)

Eriksen B C et al., “Long-term electrostimulation of the pelvic floor: primary therapy in female stress incontinence,” Urol. Int. 44: 90-5 (1989)

Nissenkorn I et al., “Patient-adjusted intermittent electrostimulation for treating stress and urge urinary incontinence,” BJU Int. 94 (1):105-9 (2004)

Fischer H et al., “Minimally invasive pressure sensor for telemetric recording of intravesical pressure in the human,” Biomed Tech (Berl) 47 (1):338-41 (2002)

### SUMMARY OF THE INVENTION

In some embodiments of the present invention, a bladder state module configured for chronic implantation into the body of a patient is configured to sense and convey biological states and functions of a bladder to a patient in order to prevent bladder overdistension. Typically, the bladder state module comprises a pressure sensor, an electromyography electrode, a pair of impedance-sensing electrodes, or a strain gauge. The bladder state module generates a signal indicative of a state of the bladder, in response to increasing bladder fill-levels, and transmits the signal to a patient information module. The patient information module interprets the signal and conveys a message to the patient, in a humanly perceptible manner, providing knowledge or a sensation of a full bladder, and alerting the patient to urinate, preventing bladder overdistension. For some applications, the same sensor which senses the state of the bladder also enhances the patient's ability to achieve maximal bladder emptying by applying a signal to the bladder or to a nerve related to pelvic function.

In an embodiment, the bladder state module and/or the patient information module are coupled to a sling implanted in the patient to treat incontinence, or to any other device known in the art for treatment of incontinence. Alternatively, the bladder state module and patient information module are designated for use with a patient who has an incontinence treatment device, but the modules are not physically coupled to the device. For some applications, a bladder state module and patient information module as described herein serve to reduce increases in bladder pressure that may occur through the use of some incontinence treatment devices known in the art.

In an embodiment, the bladder state module comprises a sensor which is configured to sense an actual time of patient voiding. Alternatively or additionally, the bladder state module receives a signal from the patient that s/he is voiding. For some applications, the bladder state module, the patient information module, or another implanted component enhances the patient's ability to achieve maximal bladder emptying by applying a signal to the bladder or to a nerve related to pelvic function. For example, if one or more EMG electrodes or impedance-sensing electrodes are coupled to the bladder, these electrodes (or other electrodes) may be driven to apply a current that stimulates the bladder to contract with extra strength, thereby enhancing bladder emptying. Alternatively or additionally, if the patient information module comprises electrodes coupled to a pelvic nerve or a muscle or another tissue to alert the patient when it is time to urinate, these same electrodes (or other electrodes) may be driven to apply a signal to the pelvic nerve or the muscle or the other tissue in order to enhance bladder emptying.

Alternatively or additionally, for some applications in which the bladder state module senses the actual time of voiding, the bladder state module transmits an indication of the actual time to the patient information module, which in turn defines a patient-alert time based on the time of actual voiding and a (typically individualized) desired voiding schedule. Subsequently, at the patient-alert time, the patient information module alerts the patient to urinate, in a humanly perceptible manner.

For some applications, the bladder state module measures and stores a maximum volume of the bladder of the patient. For example, over a given period of time (e.g., one week or one month), ongoing measurements of the maximum bladder fill-level by the bladder state module may be stored. An average or peak measured maximum bladder fill-level is calculated based on the ongoing measurements, and is set as the maximum volume. Once a maximum volume is determined for the given period of time, the bladder state module defines a percentage, e.g., thirty percent, of the maximum volume to be the threshold value at which the bladder state module transmits an indication to the patient information module, which, in turn, alerts the patient in a humanly perceptible manner to urinate. Alternatively, the bladder state module transmits data generally continuously to the patient information module, and the patient information module evaluates whether to alert the patient to urinate.

In an embodiment, the patient information module is configured for chronic implantation into the body of the patient. For example, the patient information module may comprise a nerve cuff which drives a current through a sacral nerve of the patient in order to convey the bladder fill-level to the patient thereby alerting the patient that it is time to urinate. Alternatively, the patient information module comprises a nerve cuff which drives a current through a pudendal nerve of the patient. Further alternatively, the patient information module is configured for subcutaneous implantation in the body of the patient. Alternatively or additionally, the patient information module is configured to be disposed outside of the body of the patient. In one embodiment, the patient information module comprises a subcutaneous or extracorporeal vibrating device configured to vibrate upon receiving the signal from the bladder state module. Alternatively, the patient information module comprises a device configured to sound a noise in response to the signal generated by the bladder state module.

There is therefore provided, in accordance with an embodiment of the present invention, a method, including:
at a site within a patient, measuring an indication of fill-level of a bladder of the patient; and
in response to an indication of a high bladder fill-level, conveying a signal indicative of the high bladder fill-level, to the patient in a humanly-perceptible manner.

In an embodiment, the method includes identifying the patient as a patient receiving a treatment for incontinence, the treatment being associated with causing increased bladder pressure.

In an embodiment, measuring includes electromyographically measuring.

In an embodiment, measuring includes detecting a pressure signal from a pressure sensing device within the patient.

In an embodiment, measuring includes detecting a tension-indicating signal from a strain gauge within the patient.

In an embodiment, conveying the signal includes conveying when a bladder fill-level passes a threshold that is at least 100 cc.

In an embodiment, conveying the signal includes inhibiting the conveying when a bladder fill-level is less than 100 cc.

In an embodiment, conveying the signal includes driving a current into a tissue of the patient.

In an embodiment, conveying the signal includes at least one method selected from the group consisting of: activating a vibratory device coupled to the patient, sounding a noise, driving a current into a pudendal nerve of the patient, and driving a current into a sacral nerve of the patient.

In an embodiment, the method includes assessing a post-voiding fill-level of the bladder, and calibrating the measuring of the indication of the fill-level of the bladder in response to the assessing.

In an embodiment, measuring includes measuring a maximum fill-level of the bladder and setting a threshold level in response thereto, and conveying the signal includes conveying when the fill-level passes the threshold.

In an embodiment, measuring includes measuring changes in the maximum fill-level of the bladder over a period of at least one week.

In an embodiment, measuring comprises calculating an average threshold in response thereto, and conveying the signal includes conveying when the fill-level passes the average threshold.

In an embodiment, the method includes enhancing bladder emptying by applying a bladder-emptying-enhancement current.

In an embodiment, the method includes identifying a time of actual voiding by the patient and applying the current in response to the identifying.

In an embodiment, conveying the signal indicative of the high bladder fill-level includes applying a bladder-fill-level-indicating current through an electrode, and applying the bladder-emptying-enhancement current includes applying the bladder-emptying-enhancement current through the same electrode.

In an embodiment, measuring the indication of fill-level includes sensing a measurable current using an electrode, and applying the bladder-emptying-enhancement current includes applying the current using the electrode.

There is additionally provided, in accordance with an embodiment of the present invention, a method, including:
identifying a time of actual voiding by a patient;
designating the time of actual voiding as a starting time of a time interval; and
alerting the patient to urinate at the end of the time interval.

In an embodiment, the method includes identifying the patient as a patient receiving a treatment for incontinence, the treatment being associated with causing increased bladder pressure.

In an embodiment, designating includes personalizing a duration of the time interval for the patient.

In an embodiment, alerting the patient includes driving a current through a tissue of the patient.

In an embodiment, alerting the patient includes at least one method selected from the group consisting of: activating a vibratory device coupled to the patient, sounding a noise at each successive interval, driving a current into a pudendal nerve of the patient, and driving a current into a sacral nerve of the patient.

In an embodiment, alerting the patient to urinate includes alerting when a bladder fill-level passes a threshold that is at least 100 cc.

In an embodiment, alerting the patient to urinate includes inhibiting the alerting when a bladder fill-level is less than 100 cc.

There is yet additionally provided, in accordance with an embodiment of the present invention, apparatus, including:
a bladder state module including an implantable sensor configured to sense when a patient urinates, and to generate a sensor signal in response thereto; and
a patient information module configured to receive the sensor signal from the bladder state module and to convey a message to the patient in response thereto.

In an embodiment, the sensor is configured to detect the urinating electromyographically.

In an embodiment, the sensor includes at least one pressure sensor.

In an embodiment, the sensor includes at least one strain gauge.

In an embodiment, the patient information module is configured to convey the message at a designated time greater than 1 hour following receiving the signal.

In an embodiment, the patient information module is configured for subcutaneous implantation in the body of the patient.

In an embodiment, the patient information module is configured to be disposed outside of the body of the patient.

In an embodiment, the patient information module includes at least one device selected from the group consisting of: a vibratory device, and a device configured to sound a noise in response to the signal.

In an embodiment, the patient information module is configured to convey the message when a bladder fill-level passes a threshold that is at least 100 cc.

In an embodiment, the patient information module is configured to inhibit generating the message when a bladder fill-level is less than 100 cc.

In an embodiment, the patient information module is configured for chronic implantation into the body of the patient.

In an embodiment, the patient information module includes a nerve cuff configured to drive a current through a nerve of the patient.

In an embodiment, the patient information module includes a nerve cuff configured to drive a current through a pudendal nerve of the patient.

In an embodiment, the patient information module includes a nerve cuff configured to drive a current through a sacral nerve of the patient.

In an embodiment, the apparatus is configured to enhance bladder emptying by applying a bladder-emptying-enhancement current.

In an embodiment, the bladder state module is configured to identify a time of actual voiding by the patient and to apply the current in response to the identifying.

In an embodiment, the patient information module includes an electrode, and the apparatus is configured to apply the bladder-emptying-enhancement current through the electrode.

In an embodiment, the sensor includes an electrode, and the apparatus is configured to apply the bladder-emptying-enhancement current through the electrode.

There is still additionally provided, in accordance with an embodiment of the present invention, apparatus, including:
a bladder state module, configured for chronic coupling to a bladder of a patient, and configured to generate a signal indicative of a state of the bladder; and
a patient information module, configured to be coupled to a body of the patient, to receive the signal from the bladder state module, and to convey a message to the patient, in response to the signal.

In an embodiment, the bladder state module includes at least one device selected from the group consisting of: an electromyography electrode, an electrode configured to detect an impedance of the bladder, a pressure sensor, and a strain gauge.

In an embodiment, the patient information module is configured to convey the message when a bladder fill level passes a threshold that is at least 100 cc.

In an embodiment, the patient information module is configured to inhibit conveying the message when a bladder fill-level is less than 100 cc.

In an embodiment, the patient information module is configured for subcutaneous implantation in the body of the patient.

In an embodiment, the patient information module is configured to be disposed outside of the body of the patient.

In an embodiment, the patient information module includes at least one device selected from the group consisting of: a vibratory device, and a device configured to sound a noise in response to the signal.

In an embodiment, the bladder state module is configured to assess a post-voiding fill-level of the bladder, and to calibrate the generation of the signal in response to the assessing.

In an embodiment, the bladder state module is configured to measure a maximum fill-level of the bladder and set a threshold level in response thereto, and the patient information module is configured to convey the signal when the fill-level passes the threshold.

In an embodiment, the bladder state module is configured to measure changes in the maximum fill-level of the bladder over a period of at least one week.

In an embodiment, the bladder state module is configured to calculate an average threshold in response to the measuring, and the patient information module is configured to convey the signal when the fill-level passes the average threshold.

In an embodiment, the patient information module is configured for chronic implantation into the body of the patient.

In an embodiment, the patient information module includes a nerve cuff configured to drive a current through a nerve of the patient.

In an embodiment, the patient information module includes a nerve cuff configured to drive a current through a pudendal nerve of the patient.

In an embodiment, the patient information module includes a nerve cuff configured to drive a current through a sacral nerve of the patient.

In an embodiment, the apparatus is configured to enhance bladder emptying by applying a bladder-emptying-enhancement current.

In an embodiment, the bladder state module is configured to identify a time of actual voiding by the patient and to apply the current in response to the identifying.

In an embodiment, the patient information module includes an electrode, and the apparatus is configured to apply the bladder-emptying-enhancement current through the electrode.

In an embodiment, the bladder state module includes an electrode, and the apparatus is configured to apply the bladder-emptying-enhancement current through the electrode.

In an embodiment, the electrode is configured to measure a fill-level of the bladder and apply the bladder-emptying-enhancement current.

The present invention will be more fully understood from the following detailed description of embodiments thereof, taken together with the drawings, in which:

### BRIEF DESCRIPTION OF THE DRAWINGS

FIG. 1 is a schematic illustration of a bladder state module coupled to a bladder of a patient, in accordance with an embodiment of the present invention;

FIG. 2 is a block diagram of the bladder state module in communication with a patient information module, in accordance with an embodiment of the present invention;

FIGS. 3-6 are schematic illustrations of the bladder state module in communication with the patient information module, in accordance with respective embodiments of the present invention;

FIG. 7 is a schematic illustration of the bladder state module, in accordance with an embodiment of the present invention;

FIG. 8 is a schematic illustration of the bladder state module, in accordance with another embodiment of the present invention;

FIG. 9 is a schematic illustration of the bladder state module, in accordance with yet another embodiment of the present invention; and

FIG. 10 is a schematic illustration of the bladder state module, in accordance with still another embodiment of the present invention.

### DETAILED DESCRIPTION OF EMBODIMENTS

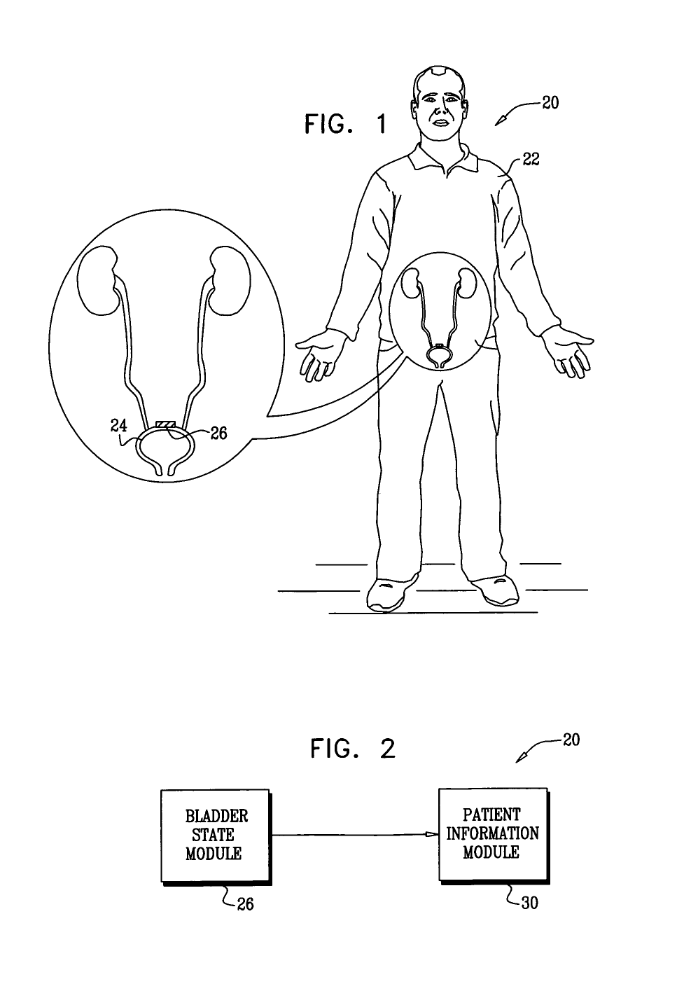

Reference is made to FIG. 1, which is a schematic illustration of apparatus 20, comprising a bladder state module 26 configured for chronic implantation in contact with a bladder 24 of a patient 22, in accordance with an embodiment of the present invention.

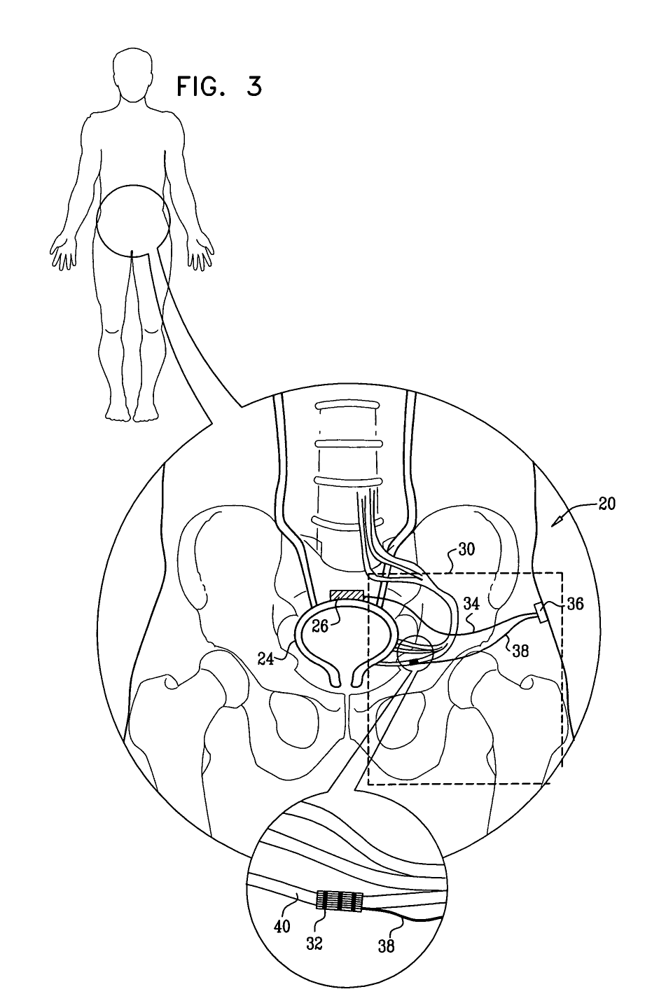

Reference is now made to FIG. 2, which is a block diagram of bladder state module 26 in communication with a patient information module 30 of apparatus 20, in accordance with an embodiment of the present invention. Bladder state module 26 is configured to intermittently or generally continuously measure bladder-fill level of bladder 24, identify an indication of a high bladder fill-level, and, in response to the identifying, generate a signal indicative of the state of bladder 24, to be conveyed to patient information module 30. Typically, bladder state module 26 conveys the signal to patient information module 30 when the fill-level of bladder 24 passes a threshold that is at least 100 cc. Alternatively or additionally, at a bladder fill-level of less than 100 cc, conveying the signal to patient information module 30 by bladder state module 26 is inhibited.

In an embodiment of the present invention, bladder state module 26 comprises an implantable sensor and is configured to identify actual voiding of patient 22. Bladder state module 26 designates a starting time of a time interval between actual voiding of patient 22 and alerting patient 22 to urinate. The duration of the time intervals between successive voiding are typically personalized for patient 22. At the end of each time interval, patient 22 is alerted to urinate by patient information module 30, in a humanly perceptible manner. Typically, patient information module 30 is programmed to alert patient 22 at a designated time greater than one hour following actual voiding. Thus, for example, patient information module 30 may be programmed to alert the patient to urinate three hours after the previously detected act of voiding.

For some applications, detecting bladder fill-level and/or detecting an actual voiding comprise techniques described in U.S. Pat. No. 6,712,772 to Cohen et al., and U.S. Pat. No. 6,354,991 to Gross et al., which are incorporated herein by reference. Alternatively or additionally, detection of bladder fill-level and/or detection of actual voiding is practiced using ultrasound, e.g., an implanted ultrasound transducer. As appropriate, techniques described in one or more of the references cited in the Background of the present patent application may be adapted for use with these embodiments of the present invention. Further alternatively or additionally, other apparatus known in the art, such as a pressure transducer, an electromyographic sensor, an electrical impedance monitor, or a strain gauge, is coupled to or in a vicinity of the bladder, in order to determine bladder-fill level.

In an embodiment, bladder state module 26 and/or patient information module 30 are coupled to a sling implanted in patient 22 to treat incontinence, or to any other device known in the art for treatment of incontinence (configurations not shown).

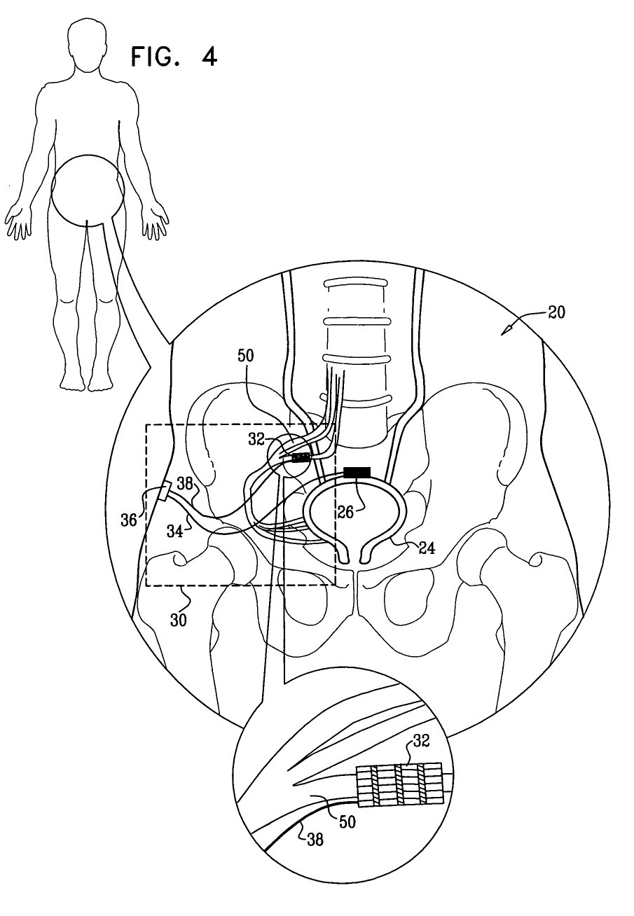

Reference is now made to FIG. 3, which is a schematic illustration of bladder state module 26 coupled to bladder 24 and in communication with patient information module 30, in accordance with an embodiment of the present invention. In this particular embodiment, patient information module 30 comprises a control unit 36 configured to receive signals from bladder state module 26 via a lead 34, coupled therebetween. Patient information module 30 further comprises a nerve cuff 32 configured to stimulate a nerve such as pudendal nerve 40 of patient 22. A signal indicative of bladder fill-level is transmitted from bladder state module 26, via lead 34, to control unit 36 implanted subcutaneously within the body of patient 22. Control unit 36 determines if the signal is indicative of the bladder being full enough to warrant encouraging voiding, and if so, drives nerve cuff 32 via a lead 38 to drive a current into pudendal nerve 40. The current driven into pudendal nerve 40 alerts patient 22 to urinate, in a humanly perceptible manner. The current typically is not configured to cause additional physiological effects, such as affecting bladder or sphincter contractions. Alternatively, in addition to the alerting function of the current, other physiological effects are engendered, such as tightening of the urethral sphincter and/or relaxation of the bladder.

Alternatively or additionally, a signal is generated by bladder state module 26 in response to a detected actual voiding of patient 22. In this case, control unit 36 receives the signal and designates a time at which patient 22 will be alerted to urinate, following the actual voiding, as described hereinabove with reference to FIG. 2. At each predetermined time, a signal is generated to activate nerve cuff 32.

Control unit 36 is programmed to distinguish between signals received, via lead 34, indicative of high bladder fill-level and other signals that do not warrant conveying the signal to patient 22. In particular, control unit 36 is typically programmed to (a) convey a signal to nerve cuff 32 upon receiving an indication of a bladder fill-level above a threshold that is typically at least 100 cc and (b) avoid conveying the signal when the bladder fill-level is below 100 cc.

It is to be noted that the placement of nerve cuff 32 around a branch of pudendal nerve 40 as shown in FIG. 3 is by way of illustration and not limitation. For example, nerve cuff 32 may be coupled to the main body, the trunk, the root, or any branch of pudendal nerve 40.

Reference is now made to FIG. 4, which is a schematic illustration of bladder state module 26 coupled to bladder 24 and in communication with patient information module 30, as described hereinabove with reference to FIG. 3, with the exception that nerve cuff 32 surrounds a sacral nerve 50, in accordance with an embodiment of the present invention. Nerve cuff 32 stimulates and drives a current through sacral nerve 50 in order to alert patient 22 to urinate, in a humanly perceptible manner.

It is to be noted that the placement of nerve cuff 32 around a branch of sacral nerve 50 as shown in FIG. 4 is by way of illustration and not limitation. For example, nerve cuff 32 may be coupled to the main body, the trunk, the root, or any branch of sacral nerve 50 that stems from the sacral plexus, or to another nerve.

Reference is now made to FIG. 5A, which is a schematic illustration of patient information module 30 comprising an external vibratory device 60, in accordance with an embodiment of the present invention. Bladder state module 26 conveys a signal to control unit 36, via lead 34, as described with reference to FIG. 3. Control unit 36 receives and processes the signal, and, if appropriate, actuates external vibratory device 60 using radiofrequency. Vibratory device 60 is typically coupled to an article of clothing such as a belt 62 worn around the body of patient 22 and configured to vibrate upon receiving a signal indicative of a high bladder-fill-level, consequently alerting patient 22 to urinate. Alternatively, vibratory device 60 is configured to vibrate at the end of each predetermined time interval personalized to patient 22 according to a preceding actual voiding of patient 22, as described hereinabove.

Reference is now made to FIG. 5B, which is a schematic illustration of patient information module 30 comprising vibratory device 60 as described hereinabove with reference to FIG. 5A, with the exception that vibratory device 60 is configured for subcutaneous implantation within patient 22, in accordance with an embodiment of the present invention. For some applications, control unit 36 and vibratory device 60 are integrated into a single housing (as shown). For some applications, vibratory device 60 and control unit 36 are not integrated into a single housing (not shown). For this particular embodiment, vibratory device 60 is disposed at a subcutaneous location apart from control unit 36 and is typically coupled thereto by an electrical lead.

For some applications, subcutaneously-implanted control unit 36 comprises a push-button by which the patient alerts bladder state module 26 that s/he is voiding. For some applications, bladder state module 26, patient information module 30, or another implanted component enhances the patient's ability to achieve maximal bladder emptying by applying a signal to bladder 24 or to a nerve related to pelvic function. For example, if one or more EMG electrodes or impedance-sensing electrodes are coupled to bladder 24, these electrodes (or other electrodes) may be driven to apply a current that stimulates bladder 24 to contract with extra strength, thereby enhancing bladder emptying.

Reference is now made to FIG. 6, which is a schematic illustration of patient information module 30 comprising an alarm 70 configured as a watch and worn on the wrist of patient 22, in accordance with an embodiment of the present invention. Bladder state module 26 conveys a signal to control unit 36, via lead 34, as described with reference to FIG. 3. Control unit 36 receives and interprets the signal, and, if appropriate, actuates alarm 70. Alarm 70 is configured to sound a noise upon receiving a signal indicative of a high bladder-fill-level, consequently alerting patient 22 to urinate. Alternatively, alarm 70 is configured to sound a noise at the end of each predetermined time interval personalized to patient 22 according to a preceding actual voiding of patient 22, as described hereinabove.

It will be appreciated that the various embodiments of patient information module 30 may be calibrated to suit the pathology, current state, and/or habits of a given patient. For example, a stronger or longer signal may be generated by patient information module 30 if the patient is asleep or running, or if that patient tends to be non-responsive to low-level signals output by the patient information module.

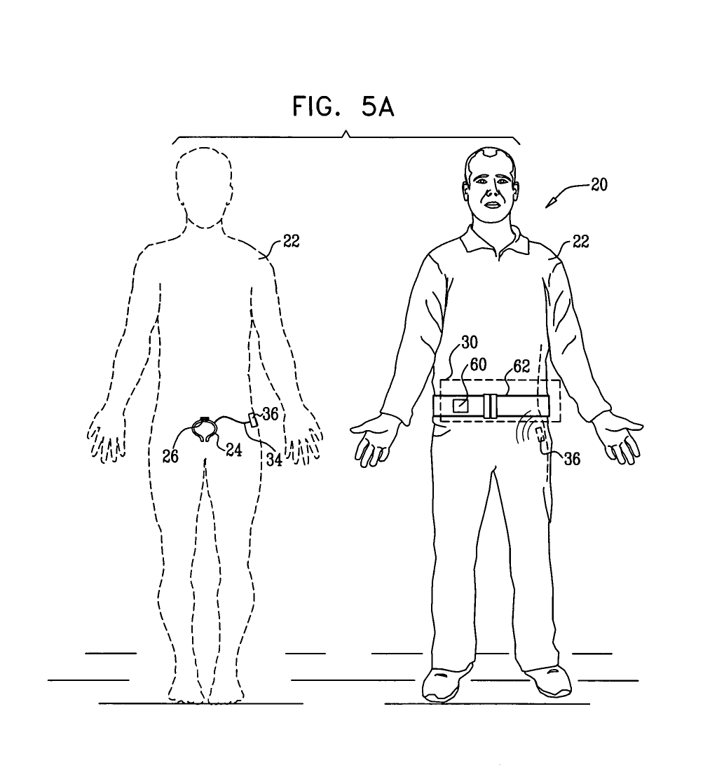

Reference is now made to FIG. 7, which is a schematic illustration of bladder state module 26 comprising a strain gauge 80 configured for chronic implantation in a wall of bladder 24, in accordance with an embodiment of the present invention. Strain gauge 80 changes its resistance or another electrical property in response to deformations that occur at various fill-levels of bladder 24, or at a time of actual voiding. The detected strain is conveyed via lead 34 to control unit 36 of patient information module 30. Patient 22 is alerted to urinate when the strain measured by strain gauge 80 is indicative of a bladder fill-level above a threshold that is typically at least 100 cc.

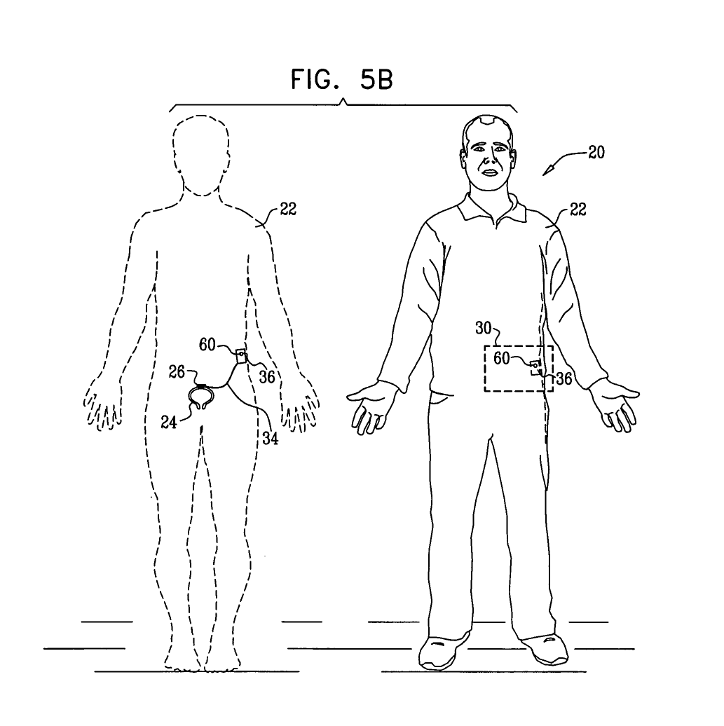

Reference is now made to FIG. 8, which is a schematic illustration of bladder state module 26 comprising one or more, e.g., three, electromyography (EMG) electrodes 90 configured for chronic implantation in or adjacent to the wall of bladder 24, in accordance with an embodiment of the present invention. For example, electrodes 90 may comprise positive, negative, and ground electrodes. As shown, two (or, alternatively, more) electromyography electrodes 90 convey a current, generated by detrusor muscle 92, which tends to vary in response to the distention of bladder 24. The current is conveyed to control unit 36 via lead 34. The current, when indicative of a high bladder fill-level, or alternatively, an actual voiding, is used to trigger an alert conveyed to patient 22 via patient information module 30, as described hereinabove. Suitable techniques of EMG analysis are described in U.S. Pat. No. 6,354,991 to Gross et al., which is incorporated herein by reference.

For some applications, three electromyography electrodes (two active electrodes and a reference electrode) are used to acquire the signal from muscle 92. The active and reference signals are processed by control unit 36. Using a three electrode array improves electromyography sensing of the changes in the current generated by detrusor muscle 92, which varies in response to the distention of bladder 24.

Alternatively or additionally, one or more electrodes 90 detect a change of impedance of bladder 24 between the electrodes that is indicative of bladder fill-level. The impedance measurements typically measure the impedance of detrusor muscle 92 between the electrodes using an applied alternating current that is typically between 0.1 kHz and 5 kHz, e.g., 1 kHz.

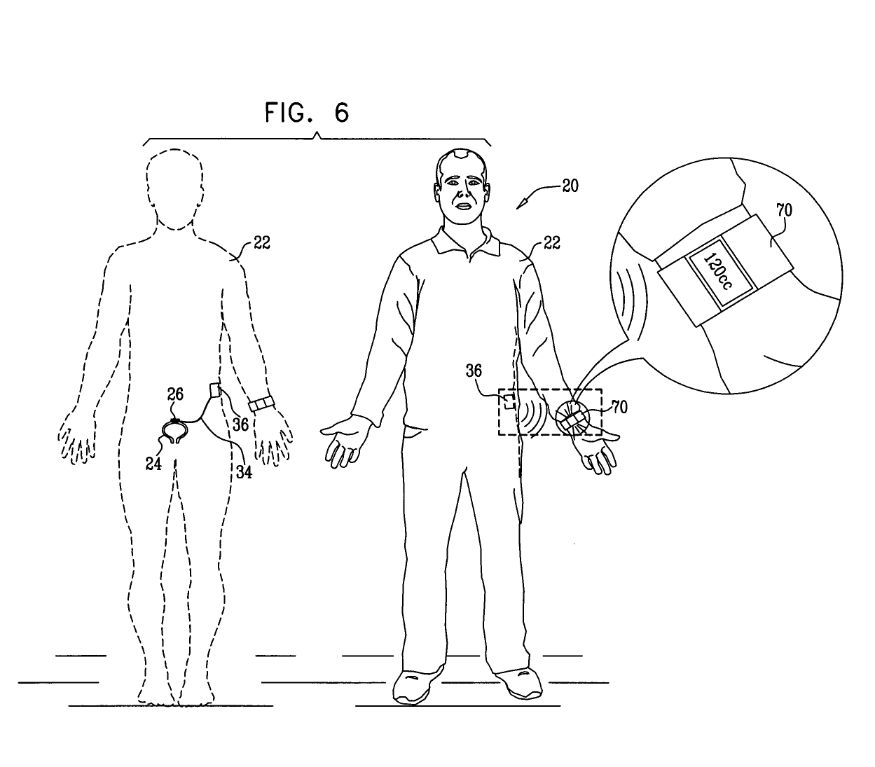

Reference is now made to FIG. 9, which is a schematic illustration of bladder state module 26 comprising a pressure sensor 100 configured for chronic implantation into bladder 24, in accordance with an embodiment of the present invention. Pressure sensor 100 detects increases in bladder pressure corresponding to increases in bladder fill-level. For some applications, techniques described in U.S. Pat. No. 6,354,992 to Gross et al., which is incorporated herein by reference, are carried out in combination with this embodiment. Pressure sensor 100 generates a signal in response to detecting a high bladder fill-level, or detecting actual voiding, and this signal is used, if appropriate, trigger an alert conveyed to patient 22, as described hereinabove.

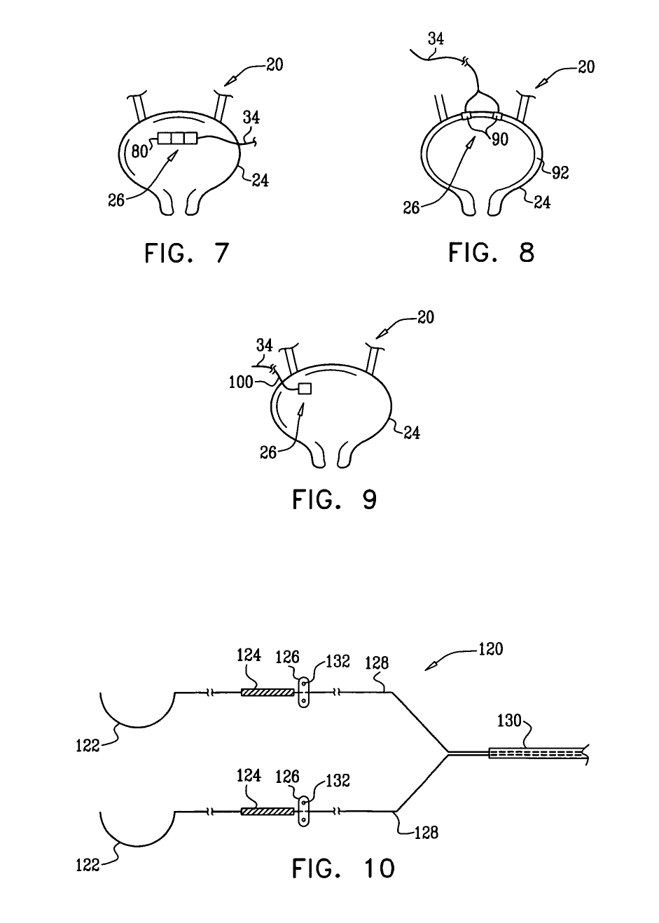

Reference is now made to FIG. 10, which is a schematic illustration of bladder state module 26 comprising a needle electrode assembly 120 configured for chronic implantation into bladder 24, in accordance with an embodiment of the present invention. Needle electrode assembly 120 comprises a pair of electrodes 124 (e.g., for functioning as electromyography electrodes and/or impedance-sensing electrodes). Electrodes 124 are coupled to control unit 36 by two discrete leads 128 extending from each electrode 124 and connected together by a connector 130.

Electrodes 124 are typically disposed on needle electrode assembly 120 at a site proximal to two curved needles 122. Needles 122 are tapered such that they can puncture and be maneuvered into and out of bladder 124, thereby implanting electrodes 124 therein, whereupon electrodes 124 are removed from assembly 120 and from the patient's body. Typically, an anchoring element 126 is disposed at a site proximal to each electrode 124, and functions to apply an anchoring force to secure the electrode to bladder 24. Each anchoring element 126 typically is shaped to define at least one hole 132 through which anchoring element 126 is sutured to bladder 24.

Reference is now made to FIGS. 1-10. For some applications, bladder state module 26, patient information module 30, or another implanted component enhances the ability of patient 22 to achieve maximal bladder emptying by applying a signal to the bladder or to a nerve or muscle related to pelvic function. For example, if one or more EMG electrodes or impedance-sensing electrodes are coupled to the bladder (FIG. 8), these electrodes (or other electrodes) may be driven to apply a current that stimulates the bladder to contract with extra strength, thereby enhancing bladder emptying. Alternatively or additionally, if patient information module 30 comprises electrodes coupled to a pelvic nerve or a muscle, to alert patient 22 when it is time to urinate (FIGS. 3 and 4), these same electrodes (or other electrodes) may be driven to apply a signal to the pelvic nerve or to another nerve or muscle in order to enhance bladder emptying. As appropriate, techniques described in references in the Background of the present patent application, or otherwise known in the art, may be utilized in carrying out these embodiments. Suitable references in this regard include the articles by Boyce et al. and Brindley et al., U.S. Pat. No. 4,771,779 and U.S. Pat. No. 6,393,323.

Reference is again made to FIGS. 1-10. Bladder state module 26 measures and stores a maximum volume of bladder 24 of patient 22. For example, over a given period of time, e.g., one week or one month, ongoing measurements of the maximum bladder fill-level by bladder state module 26 may be stored. An average or peak maximum bladder fill-level is calculated based on the ongoing measurements, and is set as the maximum volume. Once a maximum volume is determined for the given period of time, bladder state module 26 defines a percentage, e.g., thirty percent, of the maximum volume to be the threshold value at which bladder state module 26 transmits an indication to patient information module 30, which, in turn, alerts patient 22 in a humanly perceptible manner to urinate. It is to be noted that alerting patient 22 to urinate in this manner may occur independently of or in combination with alerting patient 22 when the fill-level of bladder 24 passes a threshold that is at least 100 cc, as described hereinabove.

Reference is yet again made to FIGS. 1-10. In an embodiment, bladder state module 26, patient information module 30, or another implanted apparatus comprise at least two coils, e.g., an array of coils, configured for subcutaneous implantation within the body of patient 22. At least one coil transmits energy to a second coil that is capable of recharging the apparatus. For some applications, the coil is coupled to and receives power from a companion coil housed in a separate unit connected to a main power supply, e.g., disposed within control unit 36. The coils can be of different sizes and shapes, e.g., rectangular, circular or ellipsoid.

In an embodiment, apparatus 20 is calibrated upon implantation. For example, after implantation of apparatus 20, a physician may observe the filling of the patient's bladder using prior art techniques (e.g., ultrasound), and indicate to bladder state module 26 the point when the bladder has filled to a suitable level for generating an alert. Subsequently, during routine operation, bladder state module 26 detects when its own measurements of the fill-level of the bladder match the point identified during initial calibration as being indicative of the suitable level for generating an alert.

For some applications, automatic calibration of apparatus 20 is ongoing during routine operation. For example, if a particular form of sensing bladder fill-level used by bladder state module 26 is likely to have long-term drift in its baseline, the bladder state module may intermittently recalibrate itself by assessing the bladder fill-level immediately after voiding, which, on average, remains generally constant barring sudden changes of the patient's condition. Typically, this assessment is based upon a plurality of post-void fill-level measurements. If appropriate for a given patient, recalibration in the physician's office may be performed intermittently (e.g., once or twice a year), or if the patient feels that improvement of the timing of the alerts could be improved.

It will be appreciated that the principles of the present invention may be applied in the treatment of various types of urinary incontinence, such as urge incontinence, stress incontinence, or overflow incontinence.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1-24. (canceled)

25. Apparatus, comprising:
a bladder state module comprising an implantable sensor configured to sense when a patient urinates, and to generate a sensor signal in response thereto; and
a patient information module configured to receive the sensor signal from the bladder state module and to convey a message to the patient in response thereto.

26. The apparatus according to claim 25, wherein the sensor is configured to detect the urinating electromyographically.

27. The apparatus according to claim 25, wherein the sensor comprises at least one pressure sensor.

28. The apparatus according to claim 25, wherein the sensor comprises at least one strain gauge.

29. The apparatus according to claim 25, wherein the patient information module is configured to convey the message at a designated time greater than 1 hour following receiving the signal.

30. The apparatus according to claim 25, wherein the patient information module is configured for subcutaneous implantation in the body of the patient.

31. The apparatus according to claim 25, wherein the patient information module is configured to be disposed outside of the body of the patient.

32. The apparatus according to claim 25, wherein the patient information module comprises at least one device selected from the group consisting of: a vibratory device, and a device configured to sound a noise in response to the signal.

33. The apparatus according to claim 25, wherein the patient information module is configured to convey the message when a bladder fill-level passes a threshold that is at least 100 cc.

34. The apparatus according to claim 25, wherein the patient information module is configured to inhibit generating the message when a bladder fill-level is less than 100 cc.

35. The apparatus according to claim 25, wherein the patient information module is configured for chronic implantation into the body of the patient.

36. The apparatus according to claim 35, wherein the patient information module comprises a nerve cuff configured to drive a current through a nerve of the patient.

37. The apparatus according to claim 35, wherein the patient information module comprises a nerve cuff configured to drive a current through a pudendal nerve of the patient.

38. The apparatus according to claim 35, wherein the patient information module comprises a nerve cuff configured to drive a current through a sacral nerve of the patient.

39. The apparatus according to claim 25, wherein the apparatus is configured to enhance bladder emptying by applying a bladder-emptying-enhancement current.

40. The apparatus according to claim 39, wherein the bladder state module is configured to identify a time of actual voiding by the patient and to apply the current in response to the identifying.

41. The apparatus according to claim 39, wherein the patient information module comprises an electrode, and wherein the apparatus is configured to apply the bladder-emptying-enhancement current through the electrode.

42. The apparatus according to claim 39, wherein the sensor comprises an electrode, and wherein the apparatus is configured to apply the bladder-emptying-enhancement current through the electrode.

43. Apparatus, comprising:
a bladder state module, configured for chronic coupling to a bladder of a patient, and configured to generate a signal indicative of a state of the bladder; and
a patient information module, configured to be coupled to a body of the patient, to receive the signal from the bladder state module, and to convey a message to the patient, in response to the signal.

44. The apparatus according to claim 43, wherein the bladder state module comprises at least one device selected from the group consisting of: an electromyography electrode, an electrode configured to detect an impedance of the bladder, a pressure sensor, and a strain gauge.

45. The apparatus according to claim 43, wherein the patient information module is configured to convey the message when a bladder fill level passes a threshold that is at least 100 cc.

46. The apparatus according to claim 43, wherein the patient information module is configured to inhibit conveying the message when a bladder fill-level is less than 100 cc.

47. The apparatus according to claim 43, wherein the patient information module is configured for subcutaneous implantation in the body of the patient.

48. The apparatus according to claim 43, wherein the patient information module is configured to be disposed outside of the body of the patient.

49. The apparatus according to claim 43, wherein the patient information module comprises at least one device selected from the group consisting of: a vibratory device, and a device configured to sound a noise in response to the signal.

50. The apparatus according to claim 43, wherein the bladder state module is configured to assess a post-voiding fill-level of the bladder, and to calibrate the generation of the signal in response to the assessing.

51. The apparatus according to claim 43, wherein the bladder state module is configured to measure a maximum fill-level of the bladder and set a threshold level in response thereto, and wherein the patient information module is configured to convey the signal when the fill-level passes the threshold.

52. The apparatus according to claim 51, wherein the bladder state module is configured to measure changes in the maximum fill-level of the bladder over a period of at least one week.

53. The apparatus according to claim 52, wherein the bladder state module is configured to calculate an average threshold in response to the measuring, and wherein the patient information module is configured to convey the signal when the fill-level passes the average threshold.

54. The apparatus according to claim 43, wherein the patient information module is configured for chronic implantation into the body of the patient.

55. The apparatus according to claim 54, wherein the patient information module comprises a nerve cuff configured to drive a current through a nerve of the patient.

56. The apparatus according to claim 54, wherein the patient information module comprises a nerve cuff configured to drive a current through a pudendal nerve of the patient.

57. The apparatus according to claim 54, wherein the patient information module comprises a nerve cuff configured to drive a current through a sacral nerve of the patient.

58. The apparatus according to claim 43, wherein the apparatus is configured to enhance bladder emptying by applying a bladder-emptying-enhancement current.

59. The apparatus according to claim 58, wherein the bladder state module is configured to identify a time of actual voiding by the patient and to apply the current in response to the identifying.

60. The apparatus according to claim 58, wherein the patient information module comprises an electrode, and wherein the apparatus is configured to apply the bladder-emptying-enhancement current through the electrode.

61. The apparatus according to claim 58, wherein the bladder state module comprises an electrode, and wherein the apparatus is configured to apply the bladder-emptying-enhancement current through the electrode.

62. The apparatus according to claim 61, wherein the electrode is configured to measure a fill-level of the bladder and apply the bladder-emptying-enhancement current.
